(19) United States
(12) Patent Application Publication
(10) Pub. No.: US 2024/0395180 A1
(43) Pub. Date: Nov. 28, 2024

(54) DYNAMIC NAVIGATION CONTENT FOR VEHICLE DISPLAY

(71) Applicant: FCA US LLC, Auburn Hills, MI (US)

(72) Inventor: Michael Bork, Troy, MI (US)

(21) Appl. No.: 18/321,907

(22) Filed: May 23, 2023

(51) Int. Cl. G09G 3/00; B60K 35/00; G02B 27/01

(52) U.S. Cl. CPC G09G 3/002; B60K 35/00; G02B 27/0101; B60K 35/23; B60K 35/28; B60K 35/81; B60K 2360/166; G01C 21/365; G02B 2027/0141; G09G 2380/10

(57) ABSTRACT

In at least some implementations, a method of displaying dynamic content in a vehicle includes determining a location of a vehicle along a path of travel, determining a vehicle speed, determining an upcoming navigation instruction to be provided to a driver of the vehicle to aid in navigating the vehicle along the path of travel, determining a dynamic content file corresponding to the upcoming navigation instruction and a total display time for the dynamic content file, determining a vehicle location at which to display the dynamic content file in the vehicle as a function of the location of the vehicle, the vehicle speed and the total display time for display the dynamic content file, and providing a display of the dynamic content file for the total display time.

### FIELD

The present disclosure relates to a method and system to provide dynamic navigation content in a vehicle.

### BACKGROUND

Vehicle navigation instructions provide static instructions verbally, for example, indicating distance to and a direction of a turn needed. The instructions are given at a set distance from the maneuver/turn needed and so are based only on vehicle location relative to the maneuver. Some vehicles include complex systems including cameras with fields of vision both into and outwardly from the vehicle, multiple sensors and other data to provide information on a screen that matches the surrounding environment, but these systems are very expensive, require a lot of computing power to utilize the real-time video feeds and sensor inputs, and require large screens to provide content as a function of the exterior environment.

### SUMMARY

In at least some implementations, a method of displaying dynamic content in a vehicle includes determining a location of a vehicle along a path of travel, determining a vehicle speed, determining an upcoming navigation instruction to be provided to a driver of the vehicle to aid in navigating the vehicle along the path of travel, determining a dynamic content file corresponding to the upcoming navigation instruction and a total display time for the dynamic content file, determining a vehicle location at which to display the dynamic content file in the vehicle as a function of the location of the vehicle, the vehicle speed and the total display time for display the dynamic content file, and providing a display of the dynamic content file for the total display time.

In at least some implementations, determining the vehicle speed is accomplished at least in part with a vehicle speed sensor. In at least some implementations, the vehicle speed is determined based upon a current vehicle speed as determined from the vehicle speed sensor and as a function of predetermined deceleration associated with a vehicle maneuver associated with the upcoming navigation instruction. In at least some implementations, the predetermined deceleration is based in part upon prior vehicle decelerations associated with the upcoming navigation instruction.

In at least some implementations, memory is included on which multiple dynamic content files are stored and wherein the dynamic content files are video animations.

In at least some implementations, the vehicle location at which to display the dynamic content file is a distance to a turn in the vehicle travel path and the distance varies as a function of the vehicle speed.

In at least some implementations, the total display time for the dynamic content file is variable and the method includes the step of determining a chosen total display time from multiple total display times.

In at least some implementations, the rate at which the dynamic content file can be displayed is variable and the method includes the step of determining a chosen rate of display for the dynamic content file from multiple rates of display. In at least some implementations, the different rates of display have different total display times.

In at least some implementations, the method also includes determining a location within a display at which to present the dynamic content file as a function of data from an inertial measurement unit. In at least some implementations, the location within the display can change during the presentation of the dynamic content file. In at least some implementations, a vehicle acceleration is determined based upon input from an inertial measurement unit and wherein the location within the display is changed as a function of the input from the inertial measurement unit.

In at least some implementations, a display system for a vehicle includes a heads-up display in the vehicle, a vehicle navigation system via which a path of travel of the vehicle to a destination is determinable, a controller coupled to the display and to a dynamic content source, a content source coupled to the controller and including multiple dynamic content files and information about the dynamic content files, a vehicle location sensor, and a vehicle speed sensor. The controller is responsive to information from the navigation system, the location sensor, the vehicle speed sensor and the content source to determine a location of the vehicle at which to display one of the dynamic content files.

In at least some implementations, the heads-up display is on, part of or in front of a vehicle windshield.

In at least some implementations, an inertial measurement unit is provided and the controller is responsive to output from the inertial measurement unit to change the location on the display at which the dynamic content file is presented.

In at least some implementations, the system includes a memory device communicated with the controller, and information associated with prior vehicle maneuvers that are associated with navigation instructions from the navigation system are stored in the memory device and the controller is responsive to the information associated with prior vehicle maneuvers, and the location of the vehicle at which to display one of the dynamic content files is determined by the controller as a function of the prior vehicle maneuvers.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 illustrates a vehicle and diagrammatically illustrates certain vehicle systems and components;

FIG. 2 illustrate the vehicle traveling along a predetermined path of travel to a destination, and approaching an intersection;

FIGS. 3-5 are representative views showing different dynamic content files provided on a Heads-Up Display (HUD) that is part of or on a vehicle windshield; and

FIG. 6 is a flowchart of a method for displaying dynamic content in a vehicle.

### DETAILED DESCRIPTION

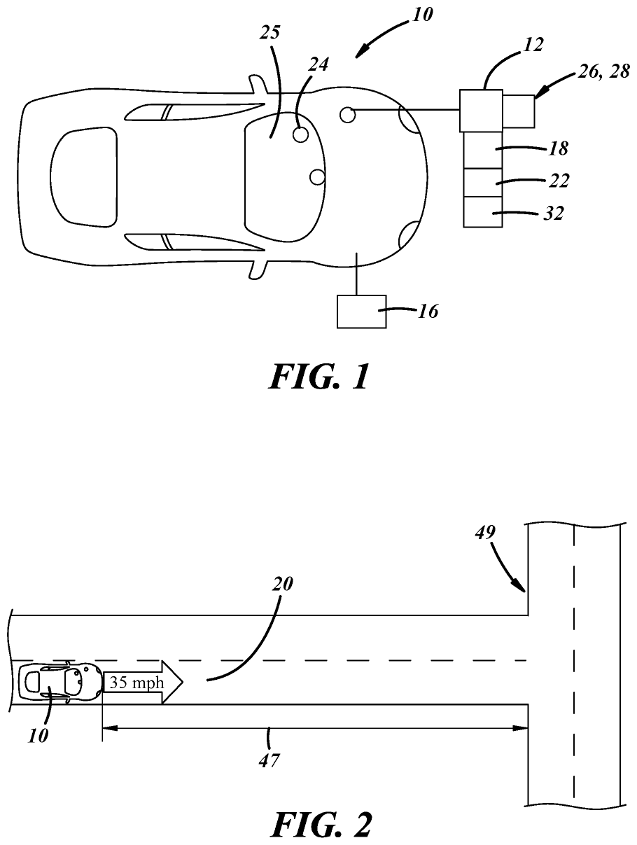

Referring in more detail to the drawings, FIG. 1 illustrates a vehicle 10 which may be of any type and size to transport a driver and optionally one or more passengers or cargo. The vehicle 10 has a controller 12 which may be part of a control system 14 that may include more than one controller coupled or networked together, a vehicle speed sensor 16 that provides an output indicative of vehicle speed, a navigation system 18 by which navigation data including a path of travel 20 (FIG. 2) may be determined, a location sensor 22 that provides an indication of the location of the vehicle 10, and a display 24 within the vehicle 10 on which information is provided to the driver. For example, information about the vehicle speed, location, path of travel 20 or other information may be provided to the driver to facilitate operation of the vehicle 10 by the driver.

The vehicle 10 may have more than one display by which information is provided to the driver. A display may be part of an instrument panel or dashboard mounted display by which various information is provided to the driver, such as information relating to a Human-Machine Interface (HMI) which enables control of climate controls, radio or other audio systems, vehicle 10 settings and the like. The display 24 may be part of a so-called Heads-Up Display 24 (HUD), where the display 24 may be part of or adjacent to a vehicle windshield 25 located at a front of a passenger compartment of the vehicle 10 and through which a driver looks to see the road and environment in front of the vehicle 10. With a HUD, a driver can see displayed information without having to look away from the road, or with having to only minimally divert their eyes from their normal view through the windshield.

The vehicle location sensor 22 may be a GPS component and from this sensor, a location of the vehicle 10 can be determined in real-time and/or at a desired intervals or a desired time. The navigation system 18 may determine a path of travel 20 as a function of the intended destination and the vehicle's starting or current location, as determined from the location sensor 22, and may utilize information from the location sensor 22 to enable determination of the position of the vehicle 10 along a desired path of travel 20. In this way, navigation information includes, among other things, a series of navigation instructions, sometimes called turn-by-turn navigation guidance, by which a driver is informed of locations at which the vehicle 10 must be turned, such as form one road to another, along the path of travel 20.

The vehicle speed sensor 16 may be the sensor commonly included with vehicles, and by which a speedometer or real-time vehicle speed is provided on an instrument panel or elsewhere so the driver can be aware of the vehicle speed. The vehicle speed sensor 16 could instead use information from the vehicle location sensor 22 with a rate of change of location used to determine vehicle speed. Both sensors 16, 22 may be used, and the information from both sensors may be compared as a sanity check or other control measure intended to improve the integrity of data or information used.

To facilitate control of the vehicle 10 and display of the information from the various sensors, the vehicle control system 14 is communicated with the sensors by wired or wireless connection. The control system 14 includes at least one controller 12. In order to perform the functions and desired processing set forth herein, as well as the computations therefore, the controller 12 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, controller 12 may include input signal processing and filtering to enable accurate sampling and conversion or acquisitions of such signals from communications interfaces and sensors.

As used herein the terms control system 14 or controller 12 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality.

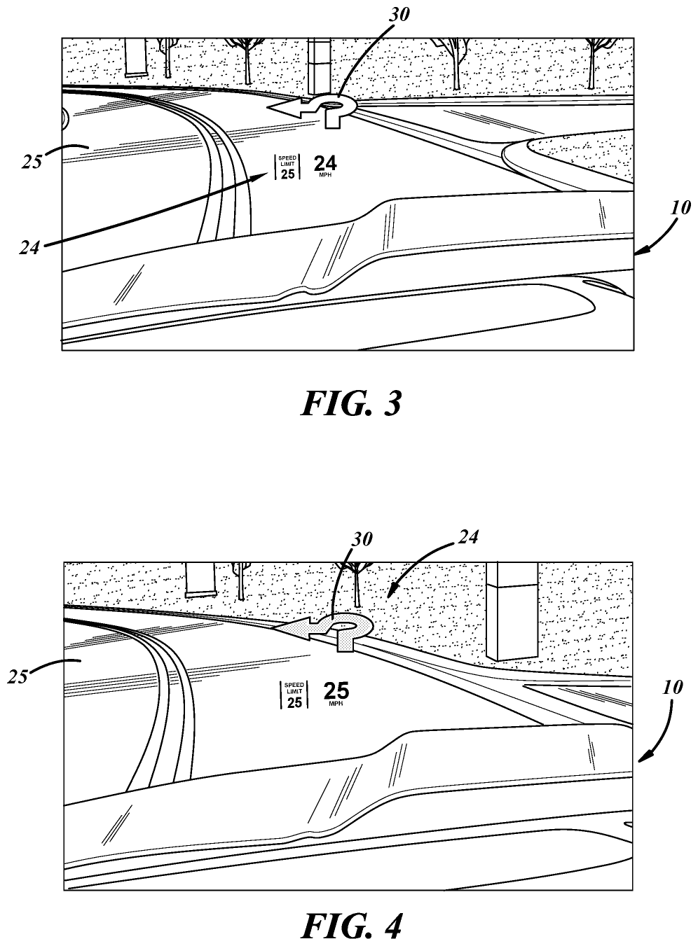

So arranged, the control system 14 is responsive to the sensors and other information to provide a display of information to the driver. In at least some implementations, the memory or other content source 26 (FIG. 1) includes multiple dynamic content files 28 that may be used to provide navigation information to the driver. The dynamic content files 28 may include video animations or a series of images arranged to be provided in some order to provide dynamic or moving information to the display 24 for viewing by the driver. By way of non-limiting examples, the dynamic content files 28 may include images of arrows, chevrons, a moving line or lines, an image of a vehicle 10 navigating a turn or other maneuver, or other direction indicators 30 (shown in FIGS. 3-5) that either move across at least part of the display 24 or are displayed in the same position in a flashing on/off (displayed/not displayed) and/or color changing manner to provide a dynamic image rather than a static direction indicator. The direction indicator(s) 30 may point in a direction of intended travel and may move in a manner that is similar to a radius or bend in an upcoming change of direction of the vehicle 10 (e.g. a bend in the road, or a turn onto a different road) needed to remain on the path of travel 20. The direction indicator(s) 30 may by dynamically presented to draw a driver's attention to the indicators 30 to increase the likelihood that the driver is aware of an upcoming vehicle maneuver needed to keep the vehicle 10 on the path of travel 20.

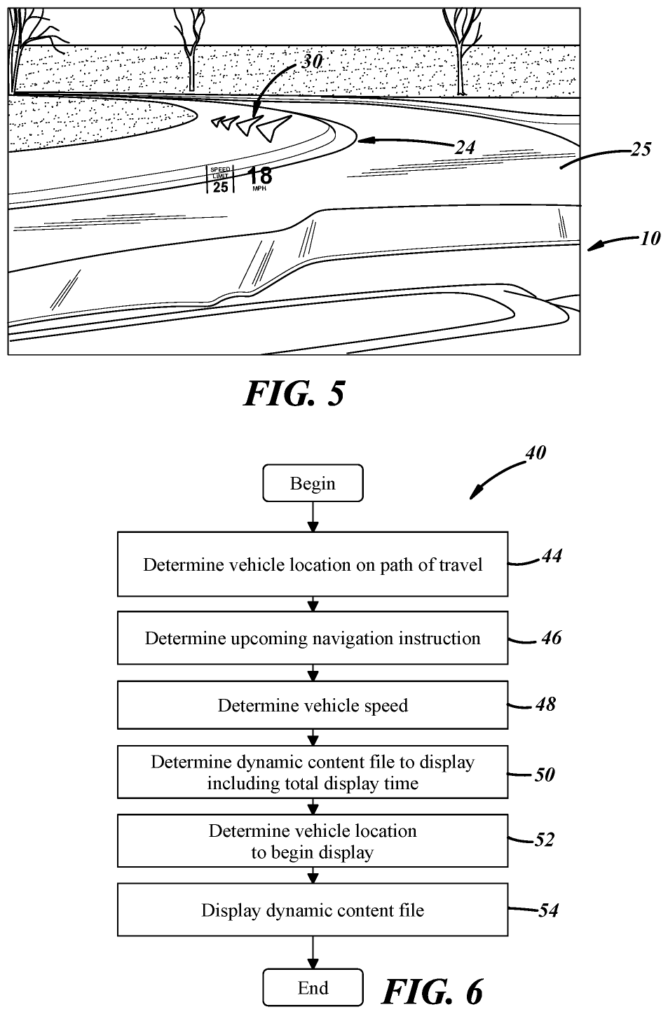

The dynamic content 28 may facilitate navigation of the vehicle 10 to one of many road options, such as at an intersection enabling turns in more than one direction, at a roundabout with more than one entry/exit point, and the like. An image representative of the road or roads or roundabout may be provided, and the arrows may traverse along the road or rounds or roundabout in the manner in which the vehicle 10 should, so the driver can see the intended path. The dynamic content 28/direction indicators 30 can be provided on the HUD in a way that they are lined-up with the road or roads ahead, with respect to the viewpoint or visions of the driver, to provide an augmented reality (AR) view in which the dynamic content 28 is/are oriented in the driver's field of view of the actual roads and not an image of the roads on the display 24. As generally shown in FIG. 5, the size of the icons or indicators 30 or other dynamic content 28 displayed may decrease from lower point on the display 24 to a higher point on the display 24 to give the appearance that the smaller and higher icons are farther away along the path of travel 20. This may mimic, for example, a series of like-sized arrows actually provided on a road, in which the farthest arrow may appear to a driver to be smallest and the nearest arrow may appear largest.

In at least some implementations, to provide a more realistic AR experience with the dynamic content, information from a vehicle inertial measurement unit (IMU 32) may be used to alter the location of dynamic content 28 on the screen 24 as a function of an orientation of the vehicle 10. The IMU 32 may be a combination of an accelerometer and a gyroscope. Linear accelerations, like the vehicle bouncing up and down, etc., are handled by the accelerometer, and angular acceleration/rotation rate, such as when the vehicle pitches due to hard acceleration or braking, speed bumps, etc., are handled by the gyroscope. By way of non-limiting examples, if the vehicle 10 is decelerating the vehicle 10 may pitch forward and downwardly and the content may be provided higher on the display 24 than when the vehicle 10 is traveling at a constant rate. Similarly, acceleration may pitch the vehicle 10 upwardly and content may be positioned lower on the display 24. Still further, jounce or bounce may be detected and the display of information moved to offset the vehicle 10 movement steadier so that the content appears to be more part of the outside environment and not fixed on the display 24.

Accordingly, detecting and taking into account vehicle accelerations/pitching/rotation, such as may be determined by the IMU 32, may improve the perception of AR and help the content appear more seamless with the environment outside the vehicle 10. In this regard, such vehicle movements can make alignment between graphical content and the intended “scene”, the environment outside the vehicle, is more difficult. This is because with a HUD, the dynamic graphics are projected onto an image plane that is a set distance away from the viewer, and if the content is meant to be overlayed or displayed relative to an object or aspect of the real world environment outside the vehicle, aligning the two so they look correct to the driver is somewhat difficult, and the IMU can help to improve alignment of the display content.

In addition to where and what to display, the time to start the display 24 and the duration of the display 24 are determined by the system. Each dynamic content file 28 may have an associated total time of display (e.g. animation runtime), or one or more or all of the files 28 may be displayed for a variable amount of time, as desired. The total time of display is the duration of the file 28 when played from beginning to end. System parameters may provide a minimum and a maximum length of time and the files 28 may have a display time between those limits. The display time may vary based upon a number of factors including the type of road on which the vehicle 10 is traveling (e.g. a highway vs. city or crowded urban roads), number of lanes in each direction, complexity of upcoming maneuver, vehicle speed and the like.

Further, the time when the display 24 should be begin so that the end of the display 24 occurs at a desired time or location 47 (FIG. 2) of the vehicle 10, can be calculated as a function of the display time, the vehicle speed and the distance of the vehicle 10 to the upcoming maneuver. For a given display time of a selected dynamic content file 28, the display 24 needs to start when the vehicle 10 is a certain time from an upcoming maneuver, and that time varies as a function of the vehicle speed. That is, the time until the vehicle 10 must navigate an upcoming maneuver (e.g. a turn at intersection 49 in FIG. 2) is shorter when the vehicle 10 is traveling faster and longer when the vehicle 10 is traveling slower. For example, if a dynamic content file 28 has a display time of eight (8) seconds, then the dynamic content file 28 needs to be started when the vehicle 10 is at a distance that the vehicle 10 will cover in about eight (8) seconds so the dynamic content matches more closely with the outside environment and provides better guidance to the driver.

Next, some dynamic content files 28 may have a playback or display speed, with a normal or nominal speed, and can be sped up or slowed-down to provide a different display and impression to a driver. For example, a file 28 played at two times the nominal speed (“2×”) will have animation that is twice as fast as when displayed at the nominal speed, and the file 28 can be played form start to end in one-half the time. In at least some implementations, the playback speed of a dynamic content file 28 may be reduced at slower vehicle speeds and increased at faster vehicle speeds, although the playback speed can be independent of speed and adjusted for other reasons including, but not limited to, user preference.

In at least some implementations, the dynamic content display system utilizes existing vehicle 10 components, sensors and information, such as controllers 12 and memory 26, vehicle speed information, location sensor 22, navigation system 18, HUD and an IMU 32. The controller 12 may be an existing controller within a vehicle and not specially added for the purpose of providing the display of dynamic content files 28. In this regard, the controller 12 may also control at least one vehicle system other than providing dynamic content file on the display (for example, but not limited to, application software that is part of the HMI, and/or audio/video content receiving of playback). In this way, a cost-effective solution to providing dynamic navigation content can be provided that does not require a large, expensive display screen (which may be a large part of a windshield) or high computing power. Instead, the system may display content as a function of the vehicle speed, location and a time needed for a dynamic content display.

A method 40 of displaying dynamic content on a vehicle display 24, may include multiple steps, as shown in FIG. 6. The example method 40 shown utilizes a predetermined path of travel 20 of the vehicle 10 or may start by determining a path of travel. The path of travel 20 may be determined by a software program or application that includes map data, traffic data and the like, and in view of the current vehicle location and a user input destination. With the path of travel 20 determined, the navigation system 18 can provide instructions to a driver as to vehicle turns and maneuvers that will be needed to keep the vehicle 10 on the path of travel 20.

The method 40 may include at step 44 determining a location of the vehicle 10 along the path of travel 20, which may be done with a location sensor 22 like GPS, and which may be monitored in real-time by or in conjunction with the navigation system 18. By tracking or determining the vehicle location, the proximity of the vehicle 10 can be determined relative to upcoming maneuvers of the vehicle 10 in accordance with the path of travel 20. In this regard, at step 46, an upcoming navigation instruction may be determined as a function of the vehicle location along the path of travel. The proximity (e.g. distance 47, labeled in FIG. 2) to the upcoming maneuver may also be a function of the vehicle speed which may be determined at step 48, which is indicative of when the vehicle 10 will reach the point or location of the upcoming maneuver.

As a function of the upcoming navigation instruction, the method may continue to determine in step 50 a dynamic content file 28 that corresponds to the upcoming navigation instruction, and the method may further include determining a total display time for the dynamic content file 28. That is, a dynamic content file 28 that relates to the upcoming instruction is chosen, and an amount of time to display the file 28 is determined based upon one or more characteristics of the file (run time, playback speed, etc, as noted herein).

Next, a vehicle location at which to display the dynamic content file 28 in the vehicle 10 is determined at step 52 as a function of the location of the vehicle 10, the vehicle speed and the total display time for the dynamic content file 28. For some vehicle maneuvers, like a sharp turn (e.g. a 90-degree turn at an intersection of perpendicular roads), the driver slows the vehicle prior to the maneuver. The method may include approximating a vehicle speed deceleration, or an average vehicle speed from a given location to the location at which the presentation of the dynamic content file should finish. Thus, the determination as to when to begin presentation of a file may be made based upon a vehicle speed that is not simply the instantaneous vehicle speed as provided by the speed sensor when requested in the method, and which may be based in part or as a function of a predetermined deceleration associated with a vehicle maneuver expected or that will occur in accordance with the upcoming navigation instruction. In the example of a 90° turn, one way to calculate the start of the turn content could be the conclusion of the approach content, that is when the display of content relative to the vehicle approaching the upcoming turn concludes. In this example, the approach content can conclude when the distance to the beginning of the turn becomes zero feet, or about zero feet. After that, the next sequence of content relating to actually making the turn can be displayed and run for a time based on the vehicle speed. Another method is to use the steering wheel angle, with the display of content relating to the turn staring once the steering wheel angle has reached a threshold angle greater than zero degrees, for example between 5 degrees and 15 degrees, and concluding when the steering wheel angle returns to zero degrees.

Further, in at least some implementations, the vehicle controller may record and store for later comparison/determinations vehicle response leading up to and during certain vehicle maneuvers for use in improving the accuracy of the determination as to when to begin presentation of a dynamic content file based upon prior maneuvers of the particular vehicle 10, and/or the behavior of one or more drivers of the vehicle 10. That is, certain drivers may reduce speed more or less than others prior to and/or during a maneuver. By comparison of prior, similar maneuvers, the control system can improve the determination as to when to begin presentation of dynamic content files based on history with the vehicle and/or with a particular driver, with a so-called machine learning feedback loop.

Finally, the display or presentation of the dynamic content file 28 can be provided in step 54 on a vehicle display 24, like a HUD, for the total display time. In this way, the navigation instructions are enhanced and the likelihood that the driver can easily follow the instructions is improved.

In at least some implementations, the method 40 determines a distance to a turn in the vehicle travel path 20 at which display of the dynamic content file 28 should begin, so that the content display ends when the vehicle 10 is at the location of the turn, or otherwise as desired. In this regard, the distance at which the dynamic content file display should begin varies as a function of the vehicle speed, as the time for the vehicle 10 to reach the location of the turn will vary based upon vehicle speed. In examples wherein the total display time for the dynamic content file 28 is variable, the method can include a step of determining a chosen total display time from multiple total display times, and can then determine when to begin the display of the dynamic content file 28. In examples wherein the rate at which the dynamic content file 28 can be displayed is variable, the method can include a step of determining a chosen rate of display for the dynamic content file 28 from multiple rates of display and can then determine when to begin the display of the dynamic content file 28. In at least some implementations, the different rates of display (e.g. playback speed) cause the files 28 to have different total display times, which can be taken into account in the method.

If desired, the method may include the step of determining a location within a display 24 (e.g. an area of the display screen) at which to display the dynamic content file 28 as a function of data from an inertial measurement unit. In this regard, vehicle jounce or bounce, for example, can be at least partially compensated for to improve the perception that the dynamic content is part of the outside environment and not just on-screen content, which may make the display more realistic and provide a better user experience.

Accordingly, a relatively simple method can be employed that enables use of more complex, dynamic information on a display that can be matched up better with the environment and a vehicle's location and path of travel. The method utilizes existing and readily available information such as vehicle speed, location, path of travel and preselected dynamic content files, and does not require complex computing or immersive, large displays. By determining a length of time to display a file, a determination as to when to display the file can be made based upon the vehicle speed and location, to provide a display that ends when desired. The dynamic content may be of any desired type including video animation files of different types, like .mov, .mp4, .gif, .avchd, .mpeg, .avi, .gLTF, by way of non-limiting examples. As such, the content may include images that move/change position about the display, or that remain in the same position on the display but which include animation within that position, like flashing, color changing, etc). The file can be provided on an existing display within a vehicle, such as HUD that is part of, on or near a vehicle windshield and generally within a driver's field of vision when the driver is looking through the windshield. The position of the dynamic content on the display can change based upon vehicle dynamics, such as are determined from an IMU 32 or otherwise.

What is claimed is:

1. A method of displaying dynamic content in a vehicle, comprising:
determining a location of a vehicle along a path of travel;
determining a vehicle speed;
determining an upcoming navigation instruction to be provided to a driver of the vehicle to aid in navigating the vehicle along the path of travel;
determining a dynamic content file corresponding to the upcoming navigation instruction and a total display time for the dynamic content file;
determining a vehicle location at which to display the dynamic content file in the vehicle as a function of the location of the vehicle, the vehicle speed and the total display time for display the dynamic content file; and
providing a display of the dynamic content file for the total display time.

2. The method of claim 1 wherein the determining the vehicle speed is accomplished at least in part with a vehicle speed sensor.

3. The method of claim 1 wherein also includes memory on which multiple dynamic content files are stored and wherein the dynamic content files are video animations.

4. The method of claim 1 wherein the vehicle location at which to display the dynamic content file is a distance to a turn in the vehicle travel path and the distance varies as a function of the vehicle speed.

5. The method of claim 1 wherein the total display time for the dynamic content file is variable and the method includes the step of determining a chosen total display time from multiple total display times.

6. The method of claim 1 wherein the rate at which the dynamic content file can be displayed is variable and the method includes the step of determining a chosen rate of display for the dynamic content file from multiple rates of display.

7. The method of claim 6 wherein the different rates of display have different total display times.

8. The method of claim 1 which also includes determining a location within a display at which to present the dynamic content file as a function of data from an inertial measurement unit.

9. The method of claim 8 wherein the location within the display can change during the presentation of the dynamic content file.

10. The method of claim 9 which also includes determining a vehicle acceleration based upon input from an inertial measurement unit and wherein the location within the display is changed as a function of the input from the inertial measurement unit.

11. The method of claim 2 wherein the vehicle speed is determined based upon a current vehicle speed as determined from the vehicle speed sensor and as a function of predetermined deceleration associated with a vehicle maneuver associated with the upcoming navigation instruction.

12. The method of claim 11 wherein the predetermined deceleration is based in part upon prior vehicle decelerations associated with the upcoming navigation instruction.

13. A display system for a vehicle, comprising:
a heads-up display in the vehicle;
a vehicle navigation system via which a path of travel of the vehicle to a destination is determinable;
a controller coupled to the display and to a dynamic content source;
a content source coupled to the controller and including multiple dynamic content files and information about the dynamic content files;
a vehicle location sensor; and
a vehicle speed sensor, wherein the controller is responsive to information from the navigation system, the location sensor, the vehicle speed sensor and the content source to determine a location of the vehicle at which to provide on the display one of the dynamic content files.

14. The system of claim 13 wherein the heads-up display is on, part of or in front of a vehicle windshield.

15. The system of claim 13 which also includes an inertial measurement unit and wherein the controller is responsive to output from the inertial measurement unit to change the location on the display at which the dynamic content file is presented.

16. The system of claim 13 which also includes a memory device communicated with the controller and wherein information associated with prior vehicle maneuvers that are associated with navigation instructions from the navigation system are stored in the memory device and the controller is responsive to the information associated with prior vehicle maneuvers, and the location of the vehicle at which to display one of the dynamic content files is determined by the controller as a function of the prior vehicle maneuvers.

17. The system of claim 13 wherein the controller is within a vehicle control system and the controller also controls at least one vehicle system other than providing dynamic content file on the display.
